(19) United States
(12) Patent Application Publication
(10) Pub. No.: US 2016/0369601 A1
(43) Pub. Date: Dec. 22, 2016

(54) METHOD FOR ESTIMATING PETROPHYSICAL PROPERTIES OF A HYDROCARBON RESERVOIR

(71) Applicant: Sergey Sergeevich Safonov, Moscow (RU)

(72) Inventors: Sergey Sergeevich Safonov, Moscow (RU); Oleg Yuryevich Dinariev, Moscow (RU); Nikolay Vyacheslavovich Evseev, Moscow (RU); Alexander Yuryevich Demianov, Moscow (RU); Dmitry Anatolievich Koroteev, Moscow (RU)

(21) Appl. No.: 15/109,287

(22) PCT Filed: Dec. 30, 2013
(86) PCT No.: PCT/RU2013/001199

§ 371 Date: Jun. 30, 2016

(51) Int. Cl. E21B 41/00; G01V 99/00; G01N 15/08; E21B 49/00

(52) U.S. Cl. CPC E21B 41/0092; E21B 49/00; G01V 99/005; G01N 15/088

(57) ABSTRACT

Estimating petrophysical properties of a hydrocarbon reservoir traversed by at least one wellbore comprises obtaining at least one core sample from the wellbore and obtaining a three-dimensional (3D) porous solid image of the core sample. A 3D pore scale model is generated from the 3D porous solid image. A distribution of reservoir fluids in pores of the reservoir is simulated by a microhydrodynamic simulation using the 3D pore scale models of the core samples and at least one petrophysical property of the reservoir by a microscale modeling using the simulated distribution of the reservoir fluids is simulated by fitting the at least one simulated petrophysical property to well logging data at a depth corresponding to a depth of taking the core sample using free parameters. Governing parameters of the 3D pore scale models are extrapolated along a logged part of the wellbore and the at least one other petrophysical property is estimated by simulation.

### FIELD OF THE INVENTION

This invention relates generally to a method of characterizing hydrocarbon reservoirs, namely to estimating properties of a formation by well logging interpretation.

### BACKGROUND

At present all well logging techniques allow only indirect characterization of the natural reservoirs of fluid hydrocarbons. This means that any particular well logging method provides measurements of certain formation physical property (resistivity, spontaneous polarization, acoustic velocity, NMR response, etc.), which can be related to reservoir characterization (rock type, porosity, saturation, permeability) through experimental or theoretical correlations (like Archie's correlation between resistivity and porosity, see, for example, Bateman R. M. Open-hole Log Analysis and Formation Evaluation. Boston: IHRDC Publ., 1985, Tittman J. Geophysical Well Logging. Orlando (Florida): Academic Press, 1986, Bassiouni Z. Theory, Measurement, and Interpretation of Well Logs. Richardson (Texas): SPE, 1994).

Reconstruction of reservoir storage and transport parameters by correlations is by no means definite or all-embracing procedure. A lot of uncertainties arise due to the indirect nature of measurements, large errors in applied correlations, possibly inadequate collection of core samples or/and lack of direct petrophysical information in respect to the considered formation.

U.S. Pat. No. 6,516,080 describes a numerical method of estimating a desired physical property of a three-dimensional porous medium, said desired physical property being selected from the group consisting of fluid flow properties, electrical properties, elastic properties, permeability, electrical conductivity, and elastic wave velocity. According to this method a three-dimensional model is reconstructed from experimental two-dimensional images by statistical means; properties are calculated using a numerical solver of Navier-Stokes equations, or a Lattice-Boltzmann flow simulator, or any finite element numerical solver.

The limitations of this patent are following: patent is focused on acquisition of macroscopic properties without validation of these properties; possible multiphase and wettability effects, which are key phenomena for oil and gas reservoir characterization, are not mentioned.

The disclosed method improves reliability of well logging interpretation in terms of sensitivity to particular rock properties (mineralogy, morphology, wettability). Also it improves interpretation by fitting numerical modeling simultaneously to several well logging techniques.

### SUMMARY OF THE INVENTION

The disclosed method comprises obtaining at least one core sample from the wellbore, wherein the core sample is a 3D porous medium representing a portion of the reservoir, and obtaining a three-dimensional (3D) porous solid image of the core sample.

Then a 3D pore scale model is generated from the 3D porous solid image wherein the 3D pore scale model describes a physical pore structure in the 3D porous medium.

A distribution of reservoir fluids in pores of the reservoir is simulated by a microhydrodynamic simulation using the 3D pore scale models of the core samples and the simulated distribution of the reservoir fluids is used for simulating at least one selected petrophysical property of the reservoir by a microscale modeling.

Then at least one simulated selected petrophysical property is fitted to well logging data at a depth corresponding to a depth of taking the core sample using free parameters (for instance, by varying overall water saturation and wettability), then governing parameters of pore scale models are extrapolated along a logged part of the wellbore and at least one other petrophysical property is estimated by simulation.

The three-dimensional porous solid images of the core samples can be obtained by X-ray microtomography, 3D NMR imaging, 3D reconstruction from petrographic thin-section analysis, 3D reconstruction from Scanning-Electron Microscopy images with chemical element map obtained by Energy-dispersive X-ray spectroscopy (EDX) analysis or Raman-confocal microscopy etc.

The 3D pore scale models are generated by digital processing and morphological analysis of the obtained 3D porous solid images of the core samples by consecutive application of the image filtering, segmentation and multiple property recognition. The 3D pore scale models can be obtained by described experimental methods, or they can be stochastically generated as statistically equivalent to experimentally obtained models.

The microhydrodynamic simulation of distribution of reservoir fluids in pores of the reservoir can be based on CFD codes or a density functional modeling.

The at least one selected petrophysical property of the reservoir is selected from the group consisting of resistivity, spontaneous polarization, elastic/viscoelastic properties, NMR processes, neutron scattering/capture, thermal effects.

The free parameters used for fitting the at least one simulated selected petrophysical property to well logging data are selected from the group consisting of saturation values, porosity, petrophysical class, wettability type.

The at least one other petrophysical property is selected from the group consisting of permeability, phase permeabilities, capillary pressure.

The 3D porous solid images may contain information about 3D wettability and/or mineral distribution acquired by distribution of properties captured by 2D imaging techniques to the 3D X-ray microCT image.

### BRIEF DESCRIPTION OF THE DRAWINGS

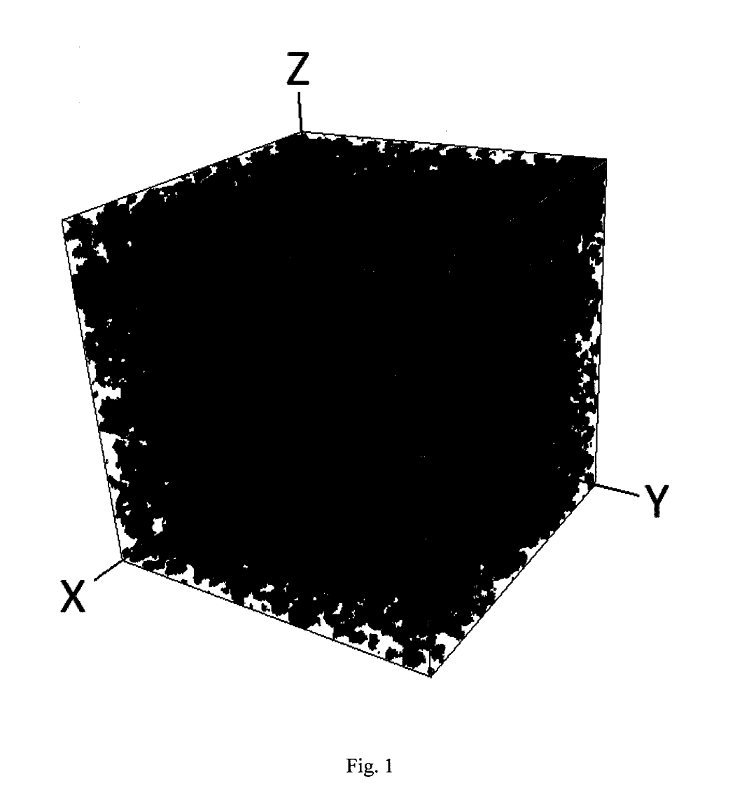

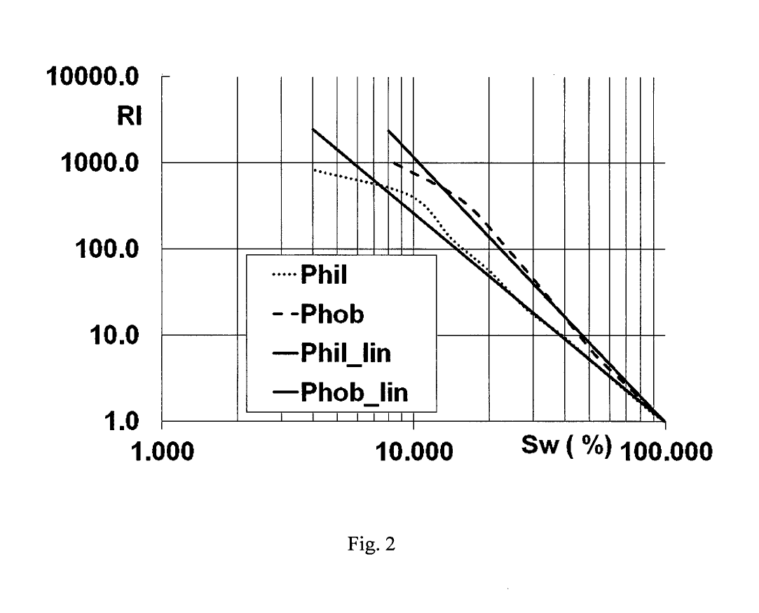

The disclosed method is explained by the drawings where FIG. 1 shows a Berea sandstone microCT model and FIG. 2 shows a resistivity index for hydrophilic and hydrophobic cases.

### DETAILED DESCRIPTION

A detailed description is provided for one embodiment of the invention, which demonstrates typical steps of our workflow in case of interpretation of well resistivity measurements in terms of water saturation distribution for the oil reservoir.

A core sample with typical petrophysical properties is obtained from a wellbore traversing a hydrocarbon reservoir. The core sample may be obtained by drilling at a selected depth and extracting a core sample.

A 3D porous solid image of the core sample is obtained by scanning the core sample. A 3D porous solid image is a 3D digital representation of the core sample. Specifically, the 3D porous solid image is an image of each portion of the core sample including pores and solid surfaces. Thus, the 3D porous solid image may show pores and rock boundaries of the core sample for each layer of the core sample. Obtaining the 3D porous solid image may be accomplished by scanning the core sample. For example, X-ray micro tomography, 3D nuclear magnetic resonance (NMR) imaging, 3D reconstruction from petrographic thin-section analysis and confocal microscopy, 3D reconstruction from analysis of 2D element maps acquired by Scanning-Electron Microscopy (SEM) with Energy-dispersive X-ray spectroscopy (EDX) function, or other technique or combination of techniques may be used to obtain the 3D porous solid image.

The 3D porous solid image is used to generate a 3D pore scale model showing realistic 3D geometry of pore-grain structure within the sample. The 3D pore scale model generator corresponds to software that includes functionality to generate a 3D pore scale model from the 3D porous solid image. To obtain the 3D pore scale model, digital processing and morphological analysis of the 3D porous solid image may be performed. Specifically, consecutive application of image filtering, segmentation and multiple property recognition may be used to obtain the 3D pore scale model of the 3D porous solid image. Morphological and geometrical statistical property analysis may further be performed to obtain information, such as pore size distribution, local and average tortuosity measurement, grain size distribution, and other properties of the core sample.

On FIG. 1 it is shown a Berea sandstone microCT model: 200*200*200 cubic cells with cell size 8.25 microns (only pores are visualized, rock matrix is made transparent, porosity=20.1%).

A distribution of reservoir fluids (oil and water) in pores of the reservoir is simulated by a microhydrodynamic simulation using the obtained 3D pore scale models of the core samples.

It is necessary to consider equilibrium distribution of water and oil in pore space with different overall water saturation taking into account an actual rock wettability. This can be done by microhydrodynamic modeling using CFD codes or the density functional modeling (see Demianov A., Dinariev O. and Evseev N., “Density functional modeling in multiphase compositional hydrodynamics,” Can. J. Chem. Eng., 89, 206-226 (2011)). In the considered example the reservoir is known to possess heterogeneous wettability dependent on particular layering. Therefore, we consider a set of oil-water saturated models, which differ by water saturation and rock wettability. Two wettability types are considered: hydrophilic and hydrophobic.

Then at least one selected petrophysical property of the reservoir is simulated by a microscale modeling using the simulated distribution of the reservoir fluids. This petrophysical property can be selected from the group consisting of resistivity, spontaneous polarization, elastic/viscoelastic properties, NMR processes, neutron scattering/capture, thermal effects. In considered example we calculate the overall electrical properties by 3D simulation of electrical current transport. These properties include an average electrical conductivity, form factor and resistivity index of the porous samples. The influence of both bulk and surface conductivity is taken into account.

In static case electric current \vec{j} obeys continuity equation

(∇,\vec{j})=0 (1)

Electrical current is related to electric field by the Ohm's law

\vec{j}=σ\vec{E} (2)

where σ—electrical conductivity. Electrical field can be represented using potential φ

\vec{E}=∇φ (3)

Combining (1)-(3) we get the equation for electric potential

(∇,σ∇φ)=0 (4)

Solving equation (4) with boundary conditions of constant applied potential jump we can calculate a potential φ, find \vec{E} and finally determine effective conductivity for the sample \hat{σ} and the form factor

F=σ_{w}/\hat{σ}=15.91,

where σ_{w} is a conductivity of the reservoir water, σ_{eff} is a conductivity of the water-saturated sample. The effective conductivity here is calculated using Ohm's law \vec{J}ₛ=σ\vec{E}ₛ, where \vec{E}ₛ is given electrical field applied to the sample and \vec{J}ₛ is calculated electrical current density. Computation of electric conductivity for two-phase saturation produce resistivity index, which depends on water saturation S_{w}

RI=σ(S=100%)/σ(S_{w}).

The results for the sample at FIG. 1 are presented at FIG. 2.

The simulated properties are fitted (are made to correspond) to well logging data obtained at a depth corresponding to a depth of taking the core using free parameters (in this case, water saturation and wettability). Well logging data are obtained by conventional logging using logging tools which can be, for example, resistivity tools, nuclear tools, borehole seismic tools, sonic logging tools. In considered example the calculated formation factors and resistivity indices are used for the interpretation for the resistivity logging data. For example, one can determine a local porosity by neutron or acoustic logging. Then by combining data on calculated formation factors and resistivity indices with particular wettability of the rock layer, one can evaluate local water saturation S_{w} from local resistivity. Then other petrophysical properties can be obtained by simulation.

Water saturation values are extrapolated along a logged part of the wellbore and the at least one other petrophysical property (for example, a distribution of capillary pressure and values of phase permeabilities) is estimated.

Embodiments may be implemented on virtually any type of computing system regardless of the platform being used.

1. Method for estimating petrophysical properties of a hydrocarbon reservoir traversed by at least one wellbore comprising:
obtaining at least one core sample from the wellbore, wherein the core sample is a three-dimensional (3D) porous medium representing a portion of the reservoir;
obtaining a three-dimensional (3D) porous solid image of the core sample;
generating a 3D pore scale model from the 3D porous solid image wherein the 3D pore scale model describes a physical pore structure in the 3D porous medium;
simulating a distribution of reservoir fluids in pores of the reservoir by a microhydrodynamic simulation using the 3D pore scale models of the core samples,
simulating at least one petrophysical property of the reservoir by a microscale modeling using the simulated distribution of the reservoir fluids,
fitting the at least one simulated petrophysical property to well logging data at a depth corresponding to a depth of taking the core sample using free parameters, and
extrapolating governing parameters of the 3D pore scale models along a logged part of the wellbore and estimating the at least one other petrophysical property by simulation.

2. The method of claim 1 wherein the three-dimensional porous solid images of the core samples are obtained by X-ray microtomography.

3. The method of claim 1 wherein the three-dimensional porous solid images of the core samples are obtained by 3D NMR imaging,

4. The method of claim 1 wherein the three-dimensional porous solid images of the core samples are obtained by 3D reconstruction from petrographic thin-section analysis etc.

5. The method of claim 4 wherein the three-dimensional porous solid images contain information about 3D mineral distribution within solid matrix.

6. The method of claim 1 wherein the three-dimensional the core images of the core samples are obtained by 3D reconstruction from Scanning-Electron Microscopy images with chemical element map obtained by Energy-dispersive X-ray spectroscopy (EDX) analysis or Raman-confocal microscopy.

7. The method of claim 1 wherein the 3D pore scale models are generated by digital processing and morphological analysis of the obtained 3D porous solid images of the core samples by consecutive application of the image filtering, segmentation and multiple property recognition.

8. The method of claim 1 wherein the 3D pore scale models are stochastically generated as statistically equivalent to experimentally obtained models.

9. The method of claim 1 wherein the microhydrodynamic simulation of distribution of reservoir fluids in pores of the reservoir is based on CFD codes or a density functional modeling.

10. The method of claim 1 wherein the at least one petrophysical property of the reservoir is selected from a group consisting of resistivity, spontaneous polarization, elastic/viscoelastic properties, NMR processes, neutron scattering/capture, thermal effects.

11. The method of claim 1 wherein the free parameters used for fitting the at least one simulated selected petrophysical property to well logging data are water saturation and wettability.

12. The method of claim 1 wherein the at least one other petrophysical property is selected from a group consisting of permeability, phase permeabilities, capillary pressure.

13. The method of claim 1 wherein the three-dimensional porous solid images contains information about 3D wettability and/or mineral distribution acquired by distribution of properties captured by 2D imaging techniques to the 3D X-ray microCT image.
